(19) United States
(12) Patent Application Publication
(10) Pub. No.: US 2014/0218860 A1
(43) Pub. Date: Aug. 7, 2014

(54) FAN CONTROLLING METHOD AND NOTEBOOK THEREOF

(71) Applicant: Quanta Computer Inc., Tao Yuan Shien (TW)

(72) Inventors: Chun-Jie YU, Keelung City (TW); Yu-Hui Chen, Tao Yuan Shien (TW)

(21) Appl. No.: 13/906,904

(22) Filed: May 31, 2013

(30) Foreign Application Priority Data
Feb. 4, 2013 (TW) 102104153

(51) Int. Cl. G06F 1/20; F04D 27/00

(52) U.S. Cl. CPC G06F 1/203; F04D 27/004; G06F 1/206
USPC 361/679.48; 416/1

(57) ABSTRACT

The fan controlling method comprises following steps: Firstly, a current rotation speed of a fan is obtained. Next, whether the current rotation speed is not greater than an expected rotation speed corresponding to the first type is determined. Then, whether a rotation speed variance between the current rotation speed and the expected rotation speed is not greater than a reasonable variance is determined when the current rotation speed is not greater than the expected rotation speed. Then, a determination that the fan belongs to the first type is made when the rotation speed variance is not greater than the reasonable variance, and a determination that the fan belongs to the second type is made when the rotation speed variance is greater than the reasonable variance, wherein the second type is different from the first type.

This application claims the benefit of Taiwan application Serial No. 102104153, filed Feb. 4, 2013, the subject matter of which is incorporated herein by reference.

### BACKGROUND OF THE INVENTION

1. Field of the Invention

The invention relates in general to a fan, and more particularly to a fan controlling method and a notebook computer thereof.

2. Description of the Related Art

As the notebook computer gets more and more powerful, the temperature of the internal circuits of the notebook computer also gets higher and higher, and it has become a prominent task for the manufacturers to provide an excellent dissipation environment to the notebook computer. The dissipation fan which creates a flow of air for dissipating the heat generated by the electronic elements of the notebook computer is a major dissipation device in the notebook computer.

In mass production, the notebook computer normally has many sources of parts and materials for choice. The cooling system also has many types of design available for choice. However, different designs of the cooling system lead to different control methods of the fan rotation speed. The conventional fan controlling method can dynamically compensate the difference between the fans provided by the same manufacturer to achieve an expected stable rotation speed. In order to meet the various specifications of the fans provided by different manufacturers and achieve the minimum fan speed switch noise, normally the minimum initial settings of the fan driving value under the same rotation speed is used, and such design can minimize the fan rotation speed during switching. However, if there is a huge difference between manufacturers' driving settings for achieving the same fan rotation speed, the steady state time for adjusting the fan rotation speed of the fan provided by a particular manufacturer to achieve an expected rotation speed would be too long.

### SUMMARY OF THE INVENTION

The invention is directed to a fan controlling method and a notebook computer thereof.

According to an embodiment of the present invention, a fan controlling method is provided. The fan controlling method comprises following steps: Firstly, a current rotation speed of a fan is obtained. Next, whether the current rotation speed is not greater than an expected rotation speed corresponding to the first type is determined. Then, whether a rotation speed variance between the current rotation speed and the expected rotation speed is not greater than a reasonable variance is determined when the current rotation speed is not greater than the expected rotation speed. Then, a determination that the fan belongs to the first type is made when the rotation speed variance is not greater than the reasonable variance, and a determination that the fan belongs to the second type is made when the rotation speed variance is greater than the reasonable variance, wherein the second type is different from the first type.

According to another embodiment of the present invention, a notebook computer is provided. The notebook computer comprises a central processor, a chipset, a fan, a memory and an embedded controller. The chipset is coupled to the central processor. The memory stores a first thermal table and a second thermal table respectively corresponding to a first type and a second type, wherein the second type is different from the first type. The embedded controller (EC) is coupled to the chipset. The embedded controller obtains a current rotation speed of a fan, and determines whether the current rotation speed is not greater than an expected rotation speed corresponding to the first type. When the current rotation speed is not greater than the expected rotation speed, the embedded controller determines whether a rotation speed variance between the current rotation speed and the expected rotation speed is not greater than the reasonable variance. When the rotation speed variance is not greater than the reasonable variance, the embedded controller determines that the fan belongs to the first type and loads in the first thermal table. When the rotation speed variance is greater than the reasonable variance, the embedded controller determines that the fan belongs to the second type and loads in the second thermal table.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 shows a block diagram of a notebook computer according to a first embodiment;

FIG. 2 shows a flowchart of a fan controlling method according to a first embodiment;

FIG. 3 shows a flowchart of an initialization procedure according to a first embodiment;

FIG. 4 shows a flowchart of a detection procedure according to a first embodiment;

FIG. 5 shows a flowchart of determining the type of a fan according to a first embodiment;

FIG. 6 shows a flowchart of a controlling procedure according to a first embodiment; and

FIG. 7 shows a flowchart of determining the type of a fan according to a second embodiment.

### DETAILED DESCRIPTION OF THE INVENTION

### First Embodiment

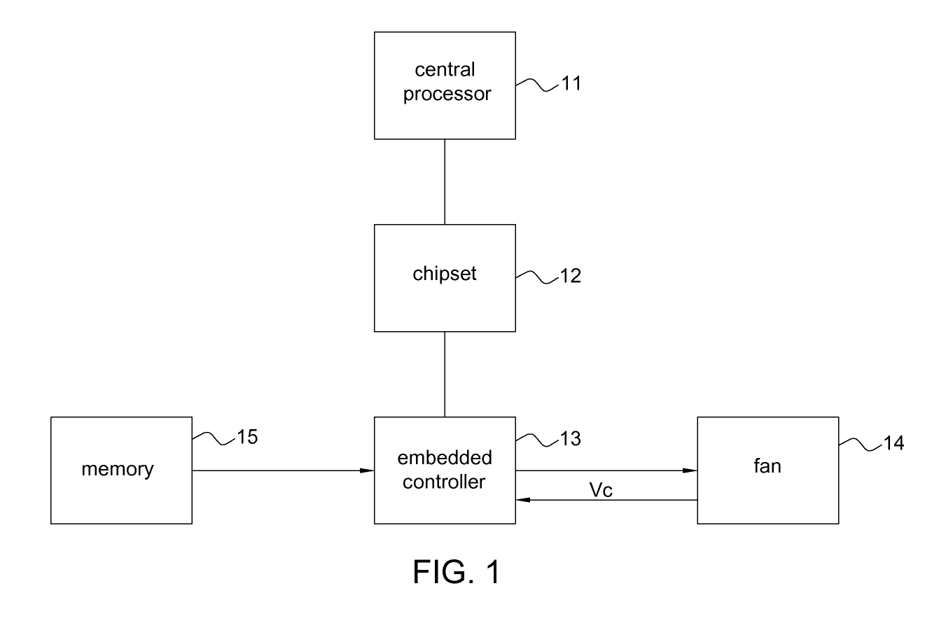

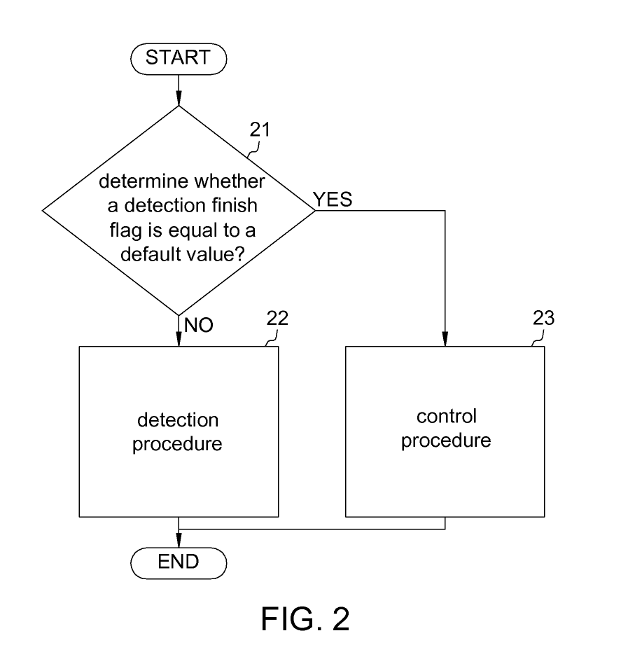

Referring to FIG. 1 and FIG. 2. FIG. 1 shows a block diagram of a notebook computer according to a first embodiment. FIG. 2 shows a flowchart of a fan controlling method according to a first embodiment. The notebook computer 1 comprises a central processor 11, a chipset 12, an embedded controller (EC) 13, a fan 14 and a memory 15. The embedded controller 13 is coupled to the memory 14, and is further coupled to the central processor 11 through the chipset 12. The memory 14 stores thermal tables corresponding to different types of the fan.

Firstly, the method begins at step 21, the embedded controller 13 determines whether a detection finish flag is equal to a default value such as 1. If the detection finish flag is not equal to the default value, then, the method proceeds to step 22, the embedded controller 13 executes a detection procedure. The detection procedure mainly determines the type of the fan 14, and loads in a thermal table corresponding to the type. Conversely, if the detection finish flag is equal to the default value, then the method proceeds to step 23, the embedded controller 13 executes a controlling procedure. The controlling procedure properly controls a rotation speed of the fan 14 such that the rotation speed of the fan 14 does not need to be frequently adjusted.

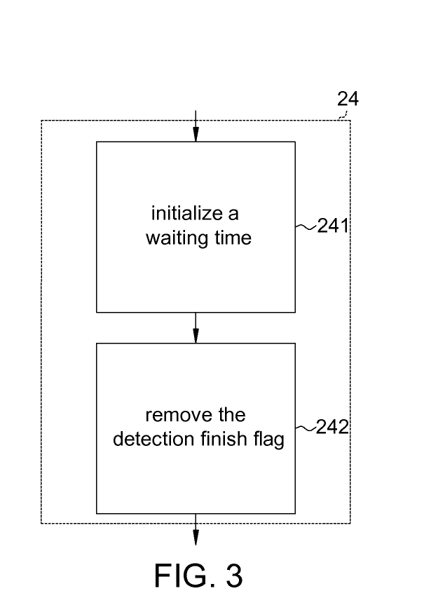

Referring to FIG. 1, FIG. 2 and FIG. 3 at the same time. FIG. 3 shows a flowchart of an initialization procedure according to a first embodiment. In addition to steps 21˜23, the controlling method may further comprise step 24. In step 24, the embedded controller 13 executes an initialization procedure before executing the detection procedure. Step 24 further comprises steps 241 and 242. Firstly, the initialization procedure begins at step 241, the embedded controller 13 initializes a waiting time such as 3 seconds. Then, the initialization procedure proceeds to step 242, the embedded controller 13 removes the detection finish flag.

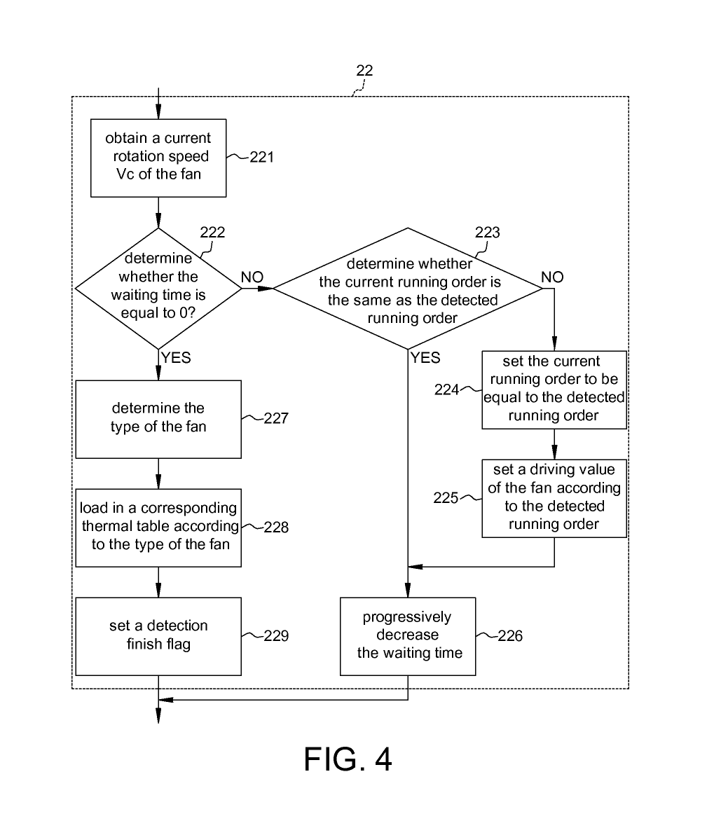

Referring to FIG. 1, FIG. 2 and FIG. 4 at the same time. FIG. 4 shows a flowchart of a detection procedure according to a first embodiment. Step 22 further comprises steps 221˜229. Firstly, the detection procedure begins at step 221, the embedded controller 13 obtains a current rotation speed Vc of the fan 14. Next, the detection procedure proceeds to step 222, the embedded controller 13 determines whether the waiting time is equal to 0, and executes step 223 when the waiting time is not equal to 0, the embedded controller 13. Then, the detection procedure proceeds to step 223, the embedded controller 13 determines whether the current running order is the same as the detected running order, and executes step 224 when the current running order is not the same as the detected running order. Then, the detection procedure proceeds to step 224, the embedded controller 13 sets the current running order to be equal to the detected running order. Then, the detection procedure proceeds to step 225, the embedded controller 13 sets a driving value of the fan 14 according to the detected running order. Then, the detection procedure proceeds to step 226, the embedded controller 13 progressively decreases the waiting time.

As the number of times of progressive decrease increases, the waiting time will eventually be progressively decreased 0. When the waiting time is not equal to 0, the detection procedure proceeds to step 227, the embedded controller 13 determines the type of the fan 14, and executes step 228 after the type of the fan 14 is determined. Then, the detection procedure proceeds to step 228, the embedded controller 13 loads in a corresponding thermal table according to the type of the fan 14, and loads in a first thermal table corresponding to the first type when the fan 14 belongs to the first type. Conversely, the embedded controller 13 loads in a second thermal table corresponding to the second type when the fan 14 belongs to the second type, wherein the second thermal table is different from the first thermal table. Then, the detection procedure proceeds to step 229, the embedded controller 13 sets a detection finish flag which indicates that the detection procedure is over.

Since the embedded controller 13 loads in different types of thermal tables according to the fan types, the embedded controller 13 can drive the fan 14 with a correct driving value, not only reducing the required time for achieving the steady state of the expected rotation speed, but further avoiding the fan 14 being overshot or undershot.

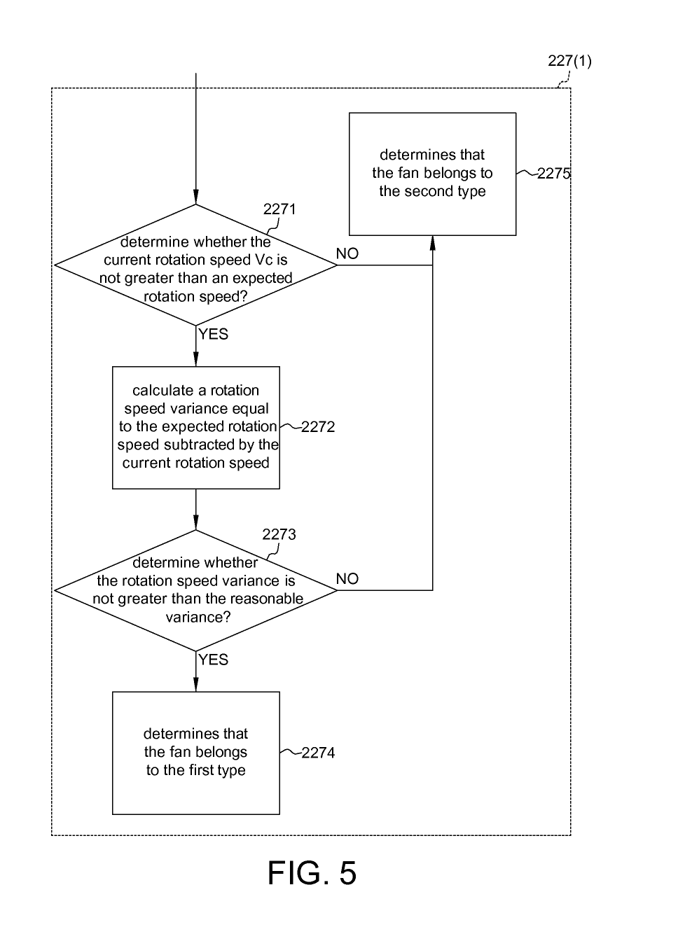

Referring to FIG. 1, FIG. 4 and FIG. 5 at the same time. FIG. 5 shows a flowchart of determining the type of a fan according to a first embodiment. Step 227 of FIG. 4 can have different implementations. Let step 227 (1) of FIG. 5 be taken for example. Step 227 (1) further comprises steps 2271˜2275. Firstly, the fan type determination procedure (1) begins at step 2271, the embedded controller 13 determines whether the current rotation speed Vc is not greater than an expected rotation speed corresponding to the first type, and executes step 2275 when the current rotation speed Vc is not greater than the expected rotation speed. In step 2275, the embedded controller 13 determines that the fan 14 belongs to the second type. For example, when the first type fan is driven with a driving value 80h, the rotation speed of the first type fan can reach 4000 rounds per minute (RPM). The embedded controller 13 sets 4000 RPM as the expected rotation speed, and determines whether the current rotation speed Vc is not greater than 4000 RPM. When the current rotation speed Vc is not greater than 4000 RPM, the embedded controller 13 determines that the fan 14 does not belongs to the first type but belongs to the second type.

Then, the fan type determination procedure (1) proceeds to step 2272, when the current rotation speed Vc is not greater than the expected rotation speed, the embedded controller 13 calculates a rotation speed variance equal to the expected rotation speed subtracted by the current rotation speed. Then, the fan type determination procedure (1) proceeds to step 2273, the embedded controller 13 determines whether a rotation speed variance between the current rotation speed Vc and the expected rotation speed is not greater than the reasonable variance.

When the rotation speed variance is not greater than the reasonable variance, the embedded controller 13 executes step 2274. Then, the fan type determination procedure (1) proceeds to step 2274, the embedded controller 13 determines that the fan 14 belongs to the first type. Conversely, when the rotation speed variance is greater than the reasonable variance, the embedded controller 13 executes step 2275. Then, the fan type determination procedure (1) proceeds to step 2275, the embedded controller 13 determines that the fan 14 belongs to the second type.

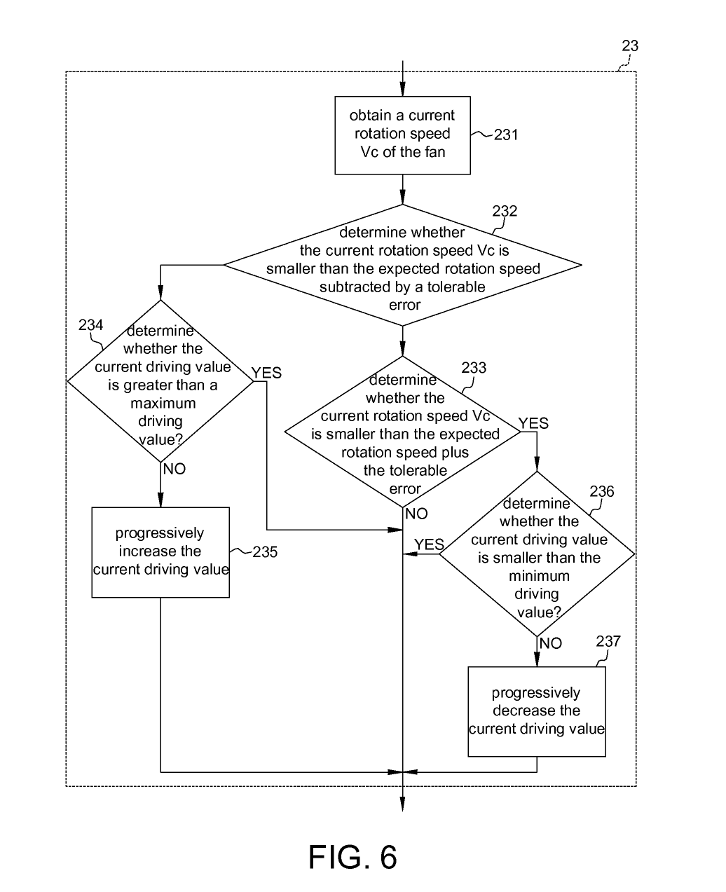

Referring to FIG. 1, FIG. 2 and FIG. 6 at the same time. FIG. 6 shows a flowchart of a controlling procedure according to a first embodiment. Step 23 further comprises steps 231˜237. Firstly, the controlling procedure begins at step 231, the embedded controller 13 obtains a current rotation speed Vc of the fan 14. Then, the controlling procedure proceeds to step 232, the embedded controller 13 determines whether the current rotation speed Vc is smaller than the expected rotation speed subtracted by a tolerable error. In general, the rotation speed of the fan has a tiny tolerable error for the influence caused by dust or environment. Therefore, the controlling procedure may further comprise the tolerable error such as 100 RPM. When the current rotation speed Vc is smaller than the expected rotation speed subtracted by the tolerable error, the embedded controller 13 executes step 234. Then, the controlling procedure proceeds to step 234, the embedded controller 13 determines whether the current driving value is greater than a maximum driving value, and executes step 235 when the current driving value is greater than the maximum driving value. Then, the controlling procedure proceeds to step 235, the embedded controller 13 progressively increases the current driving value.

When the current rotation speed Vc is not smaller than the expected rotation speed subtracted by the tolerable error, the embedded controller 13 executes step 233. Then, the controlling procedure proceeds to step 233, the embedded controller 13 determines whether the current rotation speed Vc is smaller than the expected rotation speed plus the tolerable error, and executes step 236 when the current rotation speed Vc is greater than the expected rotation speed plus the tolerable error. Then, the controlling procedure proceeds to step 236, the embedded controller 13 determines whether the current driving value is smaller than the minimum driving value, and executes step 237 when the current driving value is smaller than the minimum driving value. Then, the controlling procedure proceeds to step 237, the embedded controller 13 progressively decreases the current driving value.

### Second Embodiment

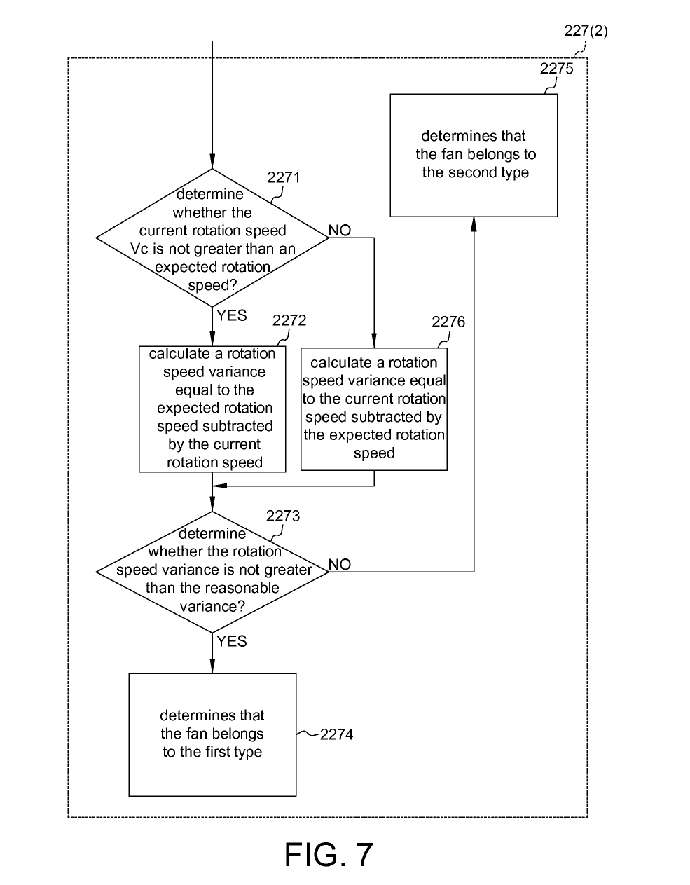

Referring to FIG. 1, FIG. 4 and FIG. 7 at the same time. FIG. 7 shows a flowchart of determining the type of a fan according to a second embodiment. Step 227 of FIG. 4 can have different implementations. Let step 227 (2) of FIG. 7 be taken for example. The second embodiment is different from the first embodiment mainly in that step 227 (2) further comprises step 2276 in addition to steps 2271˜2275. When the current rotation speed Vc is not greater than the expected rotation speed, the embedded controller 13 executes step 2276. Then, the fan type determination procedure (2) proceeds to step 2276, the embedded controller 13 calculates a rotation speed variance equal to the current rotation speed subtracted by the expected rotation speed when the current rotation speed Vc is greater than the expected rotation speed. Then, the fan type determination procedure (2) proceeds to step 2273, the embedded controller 13 determines whether the rotation speed variance is not greater than the reasonable variance.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A fan controlling method, comprising:
obtaining a current rotation speed of a fan;
determining whether the current rotation speed is not greater than an expected rotation speed corresponding to a first type;
determining whether a rotation speed variance between the current rotation speed and the expected rotation speed is not greater than a reasonable variance when the current rotation speed is not greater than an expected rotation speed;
determining that the fan belongs to the first type when the rotation speed variance is not greater than the reasonable variance; and
determining that the fan belongs to a second type when the rotation speed variance is greater than the reasonable variance, wherein the second type is different from the first type.

2. The fan controlling method according to claim 1, wherein when the current rotation speed is not greater than the expected rotation speed, the rotation speed variance is equal to the expected rotation speed subtracted by the current rotation speed.

3. The fan controlling method according to claim 1, wherein when the current rotation speed is greater than the expected rotation speed, the rotation speed variance is equal to the current rotation speed subtracted by the expected rotation speed.

4. The fan controlling method according to claim 1, further comprising:
determining whether the current rotation speed is smaller than the expected rotation speed subtracted by the tolerable error;
determining whether a current driving value of the fan is greater than a maximum driving value when the current rotation speed is smaller than the expected rotation speed subtracted by the tolerable variance; and
progressively increasing the current driving value when the current driving value is not greater than the maximum driving value.

5. The fan controlling method according to claim 4, further comprising:
determining whether the current rotation speed is greater than the expected rotation speed plus the tolerable error when the current rotation speed is not smaller than the expected rotation speed subtracted by the reasonable variance;
determining whether the current driving value is smaller than a minimum driving value when the current rotation speed is not greater than the expected rotation speed plus the tolerable error; and
progressively decreasing the current driving value when the current driving value is not smaller than the minimum driving value.

6. The fan controlling method according to claim 1, further comprising:
determining whether a waiting time is equal to 0;
determining whether a current running order of the fan is equal to a detected running order when the waiting time is not equal to 0; and
progressively decreasing the waiting time when the current running order is the same as the detected running order.

7. The fan controlling method according to claim 6, further comprising:
setting the current running order to be equal to the detected running order and setting the driving value of the fan according to the detected running order when the current running order is not the same as the detected running order.

8. The fan controlling method according to claim 1, further comprising:
loading in a first thermal table corresponding to the first type when the fan belongs to the first type; and
loading in a second thermal table corresponding to the second type when the fan belongs to the second type, wherein the second thermal table is different from the first thermal table.

9. A notebook computer, comprising:
a central processor;
a chipset coupled to the central processor;
a fan;
a memory for storing a first thermal table and a second thermal table, wherein the first thermal table and the second thermal table respectively correspond to a first type and a second type different from the first type;
an embedded controller (EC) coupled to the chipset, wherein the embedded controller obtains a current rotation speed of the fan and determines whether the current rotation speed is not greater than an expected rotation speed corresponding to the first type, and when the current rotation speed is not greater than the expected rotation speed, the embedded controller determines whether a rotation speed variance between the current rotation speed and the expected rotation speed is not greater than a reasonable variance: the embedded controller determines that the fan belongs to the first type and loads in the first thermal table when the rotation speed variance is not greater than the reasonable variance and determines that the fan belongs to the second type and loads in the second thermal table when the rotation speed variance is greater than the reasonable variance.

10. The notebook computer according to claim 9, wherein when the current rotation speed is not greater than the expected rotation speed, the rotation speed variance is equal to the expected rotation speed subtracted by the current rotation speed.

11. The notebook computer according to claim 9, wherein when the current rotation speed is greater than the expected rotation speed, the rotation speed variance is equal to the current rotation speed subtracted by the expected rotation speed.

12. The notebook computer according to claim 9, wherein the embedded controller determines whether the current rotation speed is smaller than the expected rotation speed subtracted by the tolerable error: the embedded controller determines whether a current driving value of the fan is greater than a maximum driving value when the current rotation speed is smaller than the expected rotation speed subtracted by the tolerable variance, and progressively increases the current driving value when the current driving value is not greater than the maximum driving value, the embedded controller.

13. The notebook computer according to claim 12, wherein the embedded controller determines whether the current rotation speed is greater than the expected rotation speed plus the tolerable error when the current rotation speed is not smaller than the expected rotation speed subtracted by the reasonable variance: the embedded controller determines whether the current driving value is smaller than a minimum driving value when the current rotation speed is not greater than the expected rotation speed plus the tolerable error, and progressively decreases the current driving value when the current driving value is not smaller than the minimum driving value.

14. The notebook computer according to claim 9, wherein the embedded controller determines whether a waiting time is equal to 0: the embedded controller determines whether a current running order of the fan is the same as a detected running order when the waiting time is not equal to 0, and progressively decreases the waiting time when the current running order is the same as the detected running order.

15. The notebook computer according to claim 14, wherein when the current running order is not the same as the detected running order, the embedded controller sets the current running order to be equal to the detected running order and sets the driving value of the fan according to the detected running order.
